(19) United States
(12) Patent Application Publication
(10) Pub. No.: US 2010/0036813 A1
(43) Pub. Date: Feb. 11, 2010

(54) APPARATUS AND METHOD FOR SECURELY PROCESSING ELECTRONIC MAIL

(75) Inventors: Magnus Cameron, Richmond (AU); Ashley Herring, Vermont South (AU); Justin Fowler, Wyndham Vale (AU)

Correspondence Address: KNOBBE MARTENS OLSON & BEAR LLP, 2040 MAIN STREET, FOURTEENTH FLOOR, IRVINE, CA, 92614, US

(73) Assignee: CoolRock Software Pty Ltd

(21) Appl. No.: 12/373,520

(22) PCT Filed: Jul. 12, 2007
(86) PCT No.: PCT/AU2007/000966

§ 371 Date: Sep. 2, 2009

(30) Foreign Application Priority Data
Jul. 12, 2006 (AU) 2006903761

(51) Int. Cl. H04L 9/32; G06F 15/16; G06F 17/30; H04L 9/00

(52) U.S. Cl. 707/3; 713/168; 709/206; 380/277; 707/E17.014

(57) ABSTRACT

The present invention relates to a method and apparatus for securing processing electronic mail in encrypted form and enabling access to the encrypted emails. The emails are received and stored with a common encryption key in a database. The emails can subsequently be access via the common decryption key by accessing the database.

### FIELD OF THE INVENTION

The present invention relates to a method and apparatus for securely processing electronic mail, and, particularly, but not exclusively, to a method and apparatus for processing electronic mail in encrypted form and enabling access to the encrypted emails.

### BACKGROUND OF THE INVENTION

Note that in this document the terms “electronic mail” and “email” are used synonymously.

Today, email is ubiquitous and is an integral part of a communications platform for any organisation, for handling both internal and external correspondence.

A usual architecture for handling an organisation's email includes an email server (comprising one or more server computers running appropriate software) which is arranged to provide an email communications hub for a plurality of user clients (provided by user computing devices e.g. desktop PCs, programmed with appropriate software). The email server receives email communications from outside the organisation over communication media such as the Internet, and also receives internal email communications between users within the organisation. Email communications are routed appropriately by the email server either externally (e.g. via a gateway to the Internet) or internally to the organisation's user clients.

It is also nowadays a general requirement for organisations to provide some sort of archive for storing email communications, both because the information in email communications is an important organisational resource and also because of legislative requirements (for example the Sarbanes-Oxley Act in the United States). Email documentation is therefore generally archived by organisations for a number of years.

One problem with present archives is that they are generally only accessible by a system administrator and usually store email in a fashion which makes it quite difficult to locate a particular email without a laborious search.

Another problem with present archive storage of email, relates to security requirements. Many email communications include confidential information. To protect email communications of this nature public key cryptography is often utilised. In most public key cryptography, a particular individual or organisation is allocated a public/private key pair. The public key is made available for communicating with the user/organisation and the user/organisation keeps the private key to themselves (accessible via a computing device).

The requirement for secure communications is somewhat at odds with the requirement for long term storage of email communications for access.

Conventionally, email systems organise and distribute email according to the “folder” paradigm. Received email (whether received internally or externally) is allocated to a particular folder (allocation usually occurring by the email server). Commonly, every user client will have an “In-box” folder to which all received email which hasn't yet been viewed by the user will be allocated. A user is then able to view all the email that has arrived in their In-box. Other folders are commonly provided. A “Sent items” folder is provided for each user in which items of email are allocated which have been sent by the user, a “Deleted items” folder is provided for a user to access items that they have recently deleted, etc. Further folders may be set up by system administrators, such as common “group” folders in which all email directed to a particular allocated group (e.g. “administration”) within a firm will be allocated.

There are minor variations in the architecture of email systems, but generally the folder paradigm is consistently used.

The volume and importance of email being handled by individuals is now at a level that for many employees their job productivity and efficiency can be directly linked to how effective they are of managing their In-box for each day. A common problem is that too much email may be received by a user in their In-box folder for them to efficiently handle.

Another problem is that generally any email addressed to a user will be either directly or indirectly (i.e. by being named in the cc or bcc components of the email distribution) allocated to the user by the email system. This results in many unnecessary emails being allocated to the user and therefore having to be dealt with by the user. A major example of this is “spam”. Where filters and firewalls have been devised to combat unwanted emails which may contain viruses or spam, these processes are by no means perfect (much unwanted email still get through to users even with security precautions and spam filters) and requires resources for administration.

Another consideration that the present applicants have appreciated, is that the information communicated via email is an important organisational resource which is not presently well-managed. For example, any email that passes through a user's In-box may well include useful information that may be important to access at some time in the future. It is hard to empirically judge if any given email will be useful for reference in the future. Because a user needs to delete emails, emails that may be useful for information for other users at some stage are often not easily available to those users.

The present applicants have devised a system, an embodiment of which advantageously addresses some of these problems. The applicants' system is the subject of earlier Australian patent application no. 2005906663, entitled “A Method and Apparatus for Storing and Distributing Electronic Mail”, lodged on 29 Nov. 2005. The disclosure of this earlier application is incorporated herein by reference. This earlier application discloses a system and method for processing email which avoids the folder paradigm. Instead, incoming (and outgoing) email is stored in a database which is accessible by users utilising queries to search the database for emails relevant to those queries. This has the advantage that the entire “knowledge” stored in an email database is accessible by any user at any time, only being limited by the user query and any security parameters that may be provided to limit access. Different queries can be devised (in accordance with a query language) and a user may obtain emails from across the database without being limited by any particular folder allocation.

While this earlier application addresses the problem of limited access to emails it does not address how to deal with access or archiving of secure emails which have been, for example, subject to some form of encryption.

### SUMMARY OF THE INVENTION

In accordance with a first aspect, the present invention provides a method of processing emails in an organisation having a plurality of email users, including the steps of:

receiving emails;

encrypting the emails with a common encryption key;

storing the encrypted emails in a database; and

enabling access to the emails via a common decryption key.

In an embodiment, the step of receiving emails includes the step of receiving emails which have been encrypted with encryption keys associated with one or more of the plurality of email users. In this embodiment, a further step of pre-processing the received emails is applied in order to decrypt the encrypted emails prior to their encryption with the common encryption key.

The step of pre-processing of received encrypted emails includes the step of utilising decryption keys associated with the one or more of the plurality of email users.

In an organisation, there may be a plurality of email users who each have access to their own secure email process. For example (with public key cryptography), each user may have their own public/private key pair and also may store the public keys of a number of internal and external users that they communicate with in a secure manner. Usually, the organisation has little central control over this system. With at least an embodiment of the present invention, however, access is enabled to the decryption/encryption keys utilised by the organisations users, to enable decryption in the pre-processing step.

In an embodiment, decryption/encryption keys of the one or more of the plurality of email users are stored in a common store which is accessible to enable the pre-processing. The common store may be protected by a security device, such as a password.

In an embodiment, the method includes the further step of extracting non-secure information from the emails and loading a query database with the non-secure information, the query database being searchable to locate emails. The non-secure information may include email header information.

In an embodiment, the method includes the further step of indexing words from the content of the emails by a word indexer, to prepare a word index which is searchable to locate emails.

In an embodiment, the method includes the further step of auditing access to the emails. In this way it can be determined who is accessing the emails in the encrypted database, and what they are accessing.

In an embodiment, the received emails may include all emails incoming to the organisation. They also may include all emails outgoing from the organisation and they also may include all emails being communicated internally within the organisation. In an embodiment, therefore, all emails that are associated with the organisation may be processed and stored securely in an encrypted database.

In an embodiment, the organisation may also run, in parallel with the process of this aspect of the invention, a standard email system in accordance with the usual folder paradigm. As well as emails being stored in an encrypted fashion for later use, they will also be distributed in the standard way.

In yet another embodiment, the emails may be also be stored in a non-encrypted form in a database which can be accessed via a query language. Different queries may be devised and users may obtain emails from across the database without being limited by any particular folder allocation. This is similar to the arrangement disclosed in the Applicant's earlier Patent Application No. 2005906663. This process may be run in parallel with the process of this first aspect of the invention.

The first aspect of the invention may be used to prepare a secure, encrypted store of emails which can be utilised as an archive resource. One application, for example, is where an organisation is required by law to keep records of documentation such as emails. Keeping them in secure form is advisable and may indeed to be necessary. Access to the secure store may be enabled for users having the appropriate security clearance. For example, only users in a Legal Department may be allowed access to the encrypted store, for Discovery, for example.

The term “encryption” as used in this document is intended to cover all forms of encryption, including public key cryptography (but not limited thereto). It also covers any form of securing email content so that it cannot be accessed without a process of desecuring the content. This may include security approaches other than encryption that also require security devices (such as keys) to operate them. The term “key” as used herein should be interpreted to cover any security device required to operate such a security system.

In accordance with a second aspect, the present invention provides a system for processing emails in an organisation having a plurality of email users, the system including:

a receiver for receiving emails;

encryption means for encrypting the received emails;

a database for storing the encrypted emails; and

decryption means including a common decryption key for enabling access to the emails stored in the database.

In accordance with a third aspect, the present invention provides a computer programme including instructions for controlling a computer to implement a method in accordance with the first aspect of the invention.

In accordance with a fourth aspect, the present inventions provides a computer readable medium providing a computer programme in accordance with the third aspect of the invention.

### BRIEF DESCRIPTION OF THE DRAWINGS

Features and advantages of the present invention will become apparent from the following description of embodiments thereof, by way of example only, with reference to the accompanying drawings, in which:

FIG. 1 is a diagram illustrating a conventional email system;

FIG. 2 is a schematic diagram of an email system incorporating an apparatus in accordance with an embodiment of the invention of applicants' earlier patent application no. 2005906663;

FIG. 3 is a diagram illustrating a more detailed architecture of a server component of the apparatus of FIG. 2;

FIG. 4 is a diagram illustrating how email information may be organised in a relational way in accordance with the system of FIG. 2;

FIG. 5 is a further diagram illustrating relational organisation of email information;

FIG. 6 is a representation of an example graphical user interface (GUI) that may be utilised by an apparatus in accordance with applicants' earlier patent application;

FIG. 7 is a diagram illustrating a more detailed architecture of a storage management engine component of the apparatus illustrated in FIG. 3;

FIG. 8 is a diagram illustrating an organisation of the storage means of the apparatus of FIG. 3;

FIG. 9 is a diagram of an alternative embodiment of an apparatus in accordance with an embodiment of applicants' earlier patent application no.2005906663, and

FIG. 10 is a schematic diagram of an email system in accordance with an embodiment of the present invention.

Before proceeding with a description of an embodiment of the present invention, we will firstly describe a conventional email system and then an email system in accordance with the applicants' earlier patent application, referenced above.

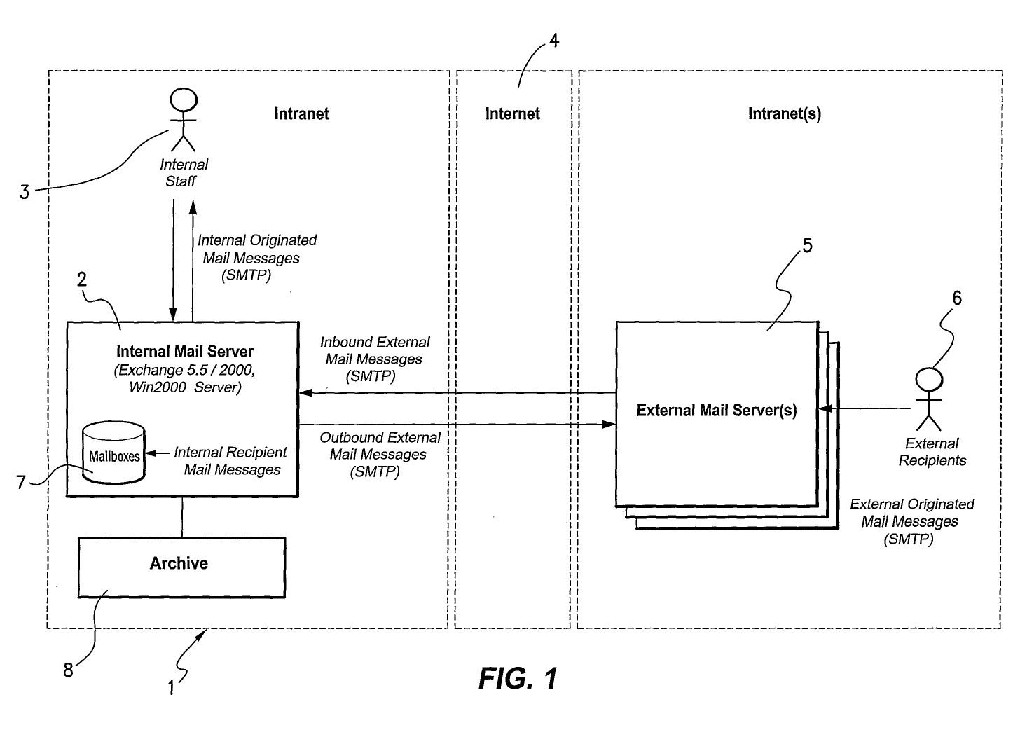

FIG. 1 is a schematic diagram of a conventional-type email system. An organisation's email system, generally designated by reference numeral 1, includes an internal email server 2 which acts as a communications hub for email for an organisation's intranet, represented by the symbol reference numeral 3. The Intranet 3 may incorporate user client devices including any conventional hardware and software such as, for example, a number of desktop PCs with the appropriate client software for receiving and displaying email served by mail server 2 and also for formulating and sending emails to mail server 2. The conventional email system 1 utilises Simple Mail Transfer Protocol (SMPT). The mail traffic encompasses:
Mail sent from internal mail accounts to other internal recipients.
Mail sent from internal mail accounts to external recipients.
Mail sent from external entities to internal recipients.

Mail sent to and received externally from the organisation will usually be routed via a gateway (not shown) and communications media such as the Internet 4. Communications will eventually be with various mail servers 5 and external recipients 6.

Some organisations may have more complex set ups, involving multiple internal mail servers and often separate servers to handle internal and external originated mail traffic. The general principal, however, is consistent.

When messages are received by the mail server 2 for internal recipients, the mail messages are allocated to the various mail boxes that have been set up (usually by the system administrator). In FIG. 1 the mail boxes are designated by reference numeral 7. Various email systems handle the distribution of mail differently. Mail may be distributed to the user client device or may remain on the mail server for access by the user client device remotely. Another architecture retains mail on the server but copies mail to the user client device. The folder paradigm, however, is consistently used regardless of the email system architecture.

In the organisation, system 1 also includes an email archive system 8. Conventional archive systems tend to be fairly vendor specific. Some systems copy emails to the archive periodically (and they then may be deleted from the server). Other archives may periodically move emails to the archive system 8. Current archive systems will generally store email in a hierarchical fashion in accordance with a policy. Storage media may include disk and tape. The archive systems are generally quite difficult to search and access is usually only allowed by secure personnel such as system administrators. Access is not generally allowed to general system users ie. client users 3.

The conventional email system, in particular the folder paradigm, has a number of problems. In particular, because emails are allocated to folders and then archived in difficult to access storage, the organisations information resource which is composed by the emails produced and received is not able to be efficiently utilised or accessed.

It is becoming more and more necessary to be able to access emails as an information resource. To give just a few simple examples:
A customer rings up asking about why they did not have an invoice item refinded on their current bill. They claim to have received an email from another employee (who has since left the organisation) who authorised and acknowledged the refund.
A new employee starts and is made a member of numerous distribution lists to ensure they are made aware of all relevant company memos. However, they have no access to that important memo sent the day before they started informing employees of new important health and safety regulations changes.

In these sorts of situations, email needs to be viewed as an information resource to be managed in much the same way as a customer contact details are managed in a CRM system, or stock inventory in an inventory management system. The ability to access this sort of rich vault of data could provide a variety of clear advantages for organisations, such as:
No “lost” correspondence. When customers or clients ring up, employees can instantly get hold of any relevant email information regarding that client and be guaranteed that the email trail they are viewing forms the complete picture of correspondence between their organisation and that client.
Improved efficiency. With an email information resource, employees do not have to chase around to find out “who said what to whom”. No need to ask their colleagues to forward on correspondence with a customer they are dealing with, or to ask that they be cc'd on important correspondence with customers.

All organisations will have particular storage requirements for all emails sent and received by their organisation, driven by not just operational requirements, but more significantly by legal and commercial requirements.

Emails are rightfully becoming recognised as crucial legal documents in their own right that a company will need access to in the case of dispute resolution with external or internal parties, such as a customer law suit against them, or an employee sexual harassment investigation. In these situations it is essential that:
All electronic correspondence between relevant parties over the relevant period be retrieved. It is particularly important that there be no gaps or missing documents so that the set of email retrieved provides as accurate a picture of the case as possible.
The authenticity of the emails is beyond reasonable dispute. The email management system must be capable of ensuring the authenticity of emails stored to avoid fake messages being sent, or existing messages being altered.
The organisation can demonstrate they have taken due diligence in storing and archiving important legal documents relating to the operation of their business. This may be particularly important in cases such as taxation audits or a customer/client/partner dispute resolution process.

Modern email systems are largely accessed through client side mail management programmes such as Outlook™ and Mozilla Mail™ that can store and manage mail boxes locally. This model has a large impact on desktop maintenance activities, particularly for large organisations. Maintenance of mail box storage limitations is a decentralised process. When staff leave, change locations or even when they receive a desktop upgrade, there are considerable desktop maintenance activities associated with deleting or migrating mailbox data.

A conventional email system, such as disclosed in relation to FIG. 1, does not provide satisfactory access to email as information resource.

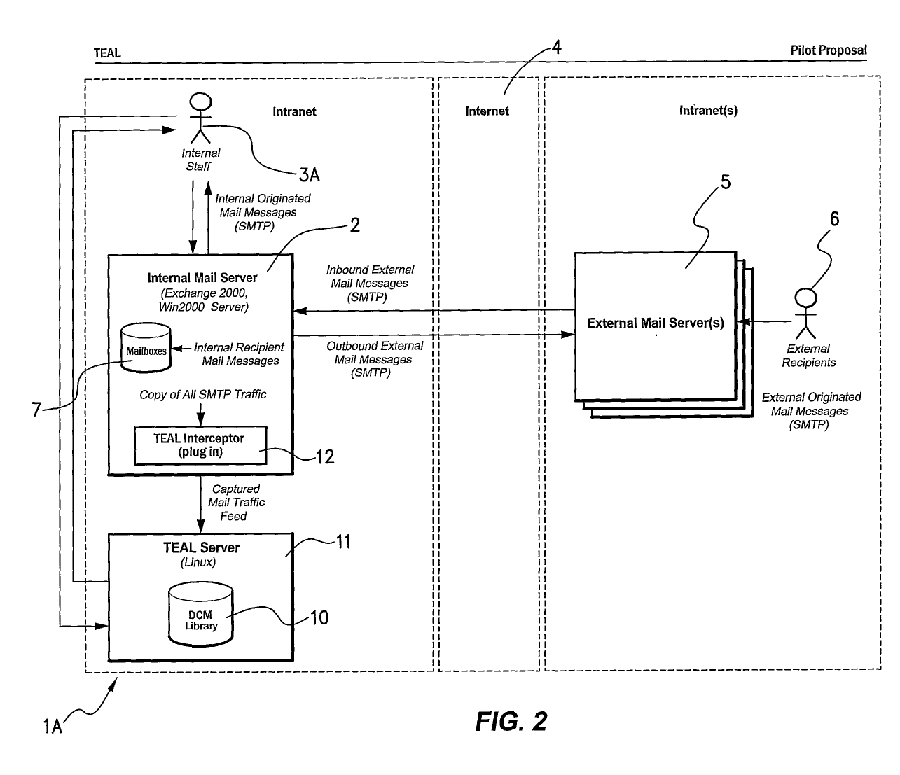

FIG. 2 is a diagram illustrating an overall architecture of an email system incorporating an apparatus in accordance with an embodiment of the invention disclosed in applicants' earlier patent application no. 2005906663.

The system illustrated in FIG. 2 includes some of the same components as the system of FIG. 1, those components have been given the same reference numerals and no further description of the similar components will be given.

The apparatus includes a database 10 which is arranged to store emails received (both from the internal intranet 3A and externally). A distribution means, in this example embodiment being in the form of a further server 11, with appropriate software (to be described in more detail later) is provided for distributing emails to users 3A in response to a step of querying the database 10. In this embodiment, user client software is provided for the user devices in order to interface with the server 11 and database 10.

In this embodiment the server 11 is designated a “TEAL” server. TEAL stands for “Transparent Email Archiving Library”.

In more detail, a TEAL interceptor 12 is provided in the form of plug-in software to the internal mail server 2. The interceptor 12 copies all SMTP email traffic and feeds it to the TEAL server 11 where it is queued for processing (see later). Each email is “normalised” to produce query index information which is stored in the database 10 and which is accessible from user clients 3A via queries to obtain the email information and access referenced emails.

The provision of the interceptor 12 enables every single email message in or out of the network 1A to be captured. This is performed in a completely transparent manner from the end users and clients, removing any adverse burden of enforcing any email archiving policy for individual clients. The archiving is done automatically by the interceptor and the TEAL server 11.

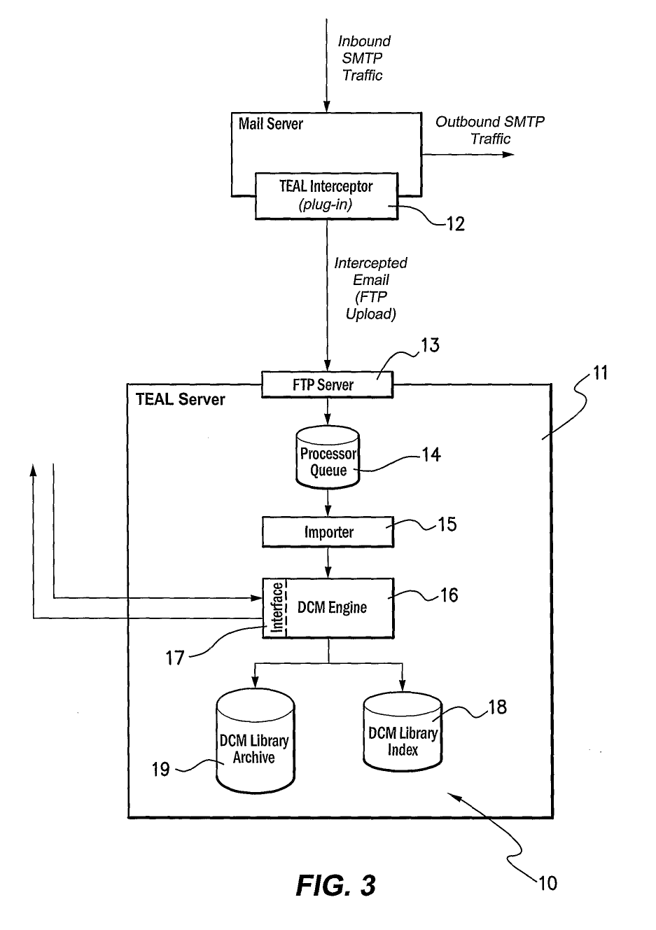

Referring to FIG. 3, in more detail the TEAL server includes an FTP server 13 which is arranged to receive intercepted mail from the TEAL interceptor 12. The upload process to the TEAL server 11 is via an FTP connection to the FTP server 13. As the TEAL interceptor 12 is likely to be intercepting very high volumes of email traffic on the email server, the burden of processing and archiving email is moved off the email server onto the TEAL server 11 at the quickest rate possible. The use of the FTP protocol ensures that the plug-in 12 remains relatively simple to implement. Email messages will be kept in an upload queue at the TEAL interceptor 12 until the FTP upload acknowledges that the email has been received and persisted to local storage 14 on the TEAL server 11. Once they have acknowledged as being uploaded, the email message will be deleted from the upload queue.

If the connection should fail at any stage (ie. due to a firewall connection timeout setting), then the upload process will attempt to reconnect the TEAL server and re-send any unacknowledged emails along with new emails flowing through the system.

The processor queue 14 or “upload queue” 14 is provided in this embodiment by a fast disc storage and provides a means of quickly storing intercepted email in a queue for subsequent processing. The email is stored as raw email content. This enables the server 11 to keep track of high volumes of emails during peak periods and no email messages are lost, without over loading the email server. The TEAL server 11 is then able to process the emails in the processor queue 14 for storage in the database 10.

An importer processor 15 is provided in server 11 and is arranged to receive emails from the processor queue 14, parse their contents and import into a storage management engine 16. The storage management engine 16 has a number of tasks, which include in this embodiment “normalisation” of the emails and storage in the database 10. The storage management engine 16 also provides an interface 17 for enabling queries by user clients and returning emails and email information to the user clients in response to the queries.

In this embodiment the storage management engine 16 is termed a “digital content management” engine (DCM engine).

The database comprises two sub-databases, in this embodiment being a library index 18 and a library archive 19. The index 18 stores query index information in the form of relationally stored meta-data about the emails. This index is produced by the storage management engine 16 by a process of normalising received emails. The relational index may be queried by utilising query language, obtaining access to the email information stored in the index and also to cross-referenced emails stored in the library archive 19. The library archive 19 stores mail message contents in a secure, accessible manner. The library archive 19 utilises a file based storage medium, rather than a relational database medium (as utilised by the library index 18). The library index 18 maintains all the required relationship and indexing information required to perform high performance, complex queries on the contents of the library archive 19.

Note that the archive as well as storing the email message contents, also stores header, body and attachments to the email.

The splitting of the relationship (library index 18) and content information (library archive 19) allows for efficient storage and organisation of the information. The information relevant to the relationships between mail messages, is placed in a relational database to allow for high performance, complex queries to be executed on them, whilst the bulk of the message, the body, which carries much less relational information, is stored on a file-system optimised for high data volume storage.

The emails are processed (as will be discussed below) and stored in the database 10 for future access by users. Emails received by the mail server 2 are therefore captured by the interceptor 12 and then processed the database 10 in real-time. There will obviously be some delay between capturing the emails and processing them to the database 10 where they can be subsequently accessed by the user client 3A. The term “real-time” in this document encompasses this processing delay.

As will be discussed in more detail later, the database 10 may be highly-vendor independent. A company may wish to utilise their own Oracle server infrastructure to host the database 10, for example, and the structure of this embodiment's architecture allows for this.

The database 10 is arranged for storage of what could potentially be a very large volume of data, which may represent every single email sent and received by an organisation's network over several years.

The TEAL server 11 and database 10 are arranged to ensure that:
Every email message placed in the database 10 will be permanently stored until it is explicitly purged by an administration process (after a predefined period of time).
No duplicate messages exist in the database 10. Each stored message will be unique and will represent a real email event that occurred in that organisation. One technique for quickly and efficiently implementing this is to generate an MD5 based on the binary contents of an email message and then use this as the primary key for that message throughout the system.
Retrieval of sets of email messages defined by any combination of possible relationship criteria is processed as quickly as the underlying relational technologies and physical storage technologies allow for.
Access controls ensure that every retrieval request the database receives is from an authenticated end user. Only email messages that end user has been authorised to view (on a per sender/recipient basis for example) will be visible to that user.
All email retrieval requests can be audited to provide authorised administrators with a full trail of which email messages have been accessed by which end users.
A capability of the system is the ability to identify and efficiently manage the many complex inter-relationships between email messages.

### Normalisation

The process of normalisation is used to organise the storage of the email messages into relational structures.

An denormalised, raw view of a set of email messages may be stored in a flat table such as:

| ID | FROM | TO | SUBJECT | DATE | PRIORITY |
|---|---|---|---|---|---|
| 1. | reservations@travelagent.com | adam@companyx.com | Your Virgin | 270/07/04 | Normal |
| | | | Blue | 15:09 | |
| | | | Itinerary for | | |
| | | | Mr A | | |
| | | | Herring | | |
| 2. | bill@companyx.com | developers@companyx.com | Re: CRC | 27/07/04 | Normal |
| | | | lookup table | 14:16 | |
| | | | generation | | |
| 3. | jason@companyx.com | developers@companyx.com | Alarm | 27/07/04 | Normal |
| | | | | 08:30 | |
| 4. | henry@companyx.com | adam@companyx.com | FW: | 26/07/04 | High |
| | | | Strategy | 15:34 | |

This is typically how traditional email systems store email. Identifying relationships within a denormalised structure will typically require a linear scan of the whole table, which would be impractical when dealing with thousands, if not tens of thousands of email messages.

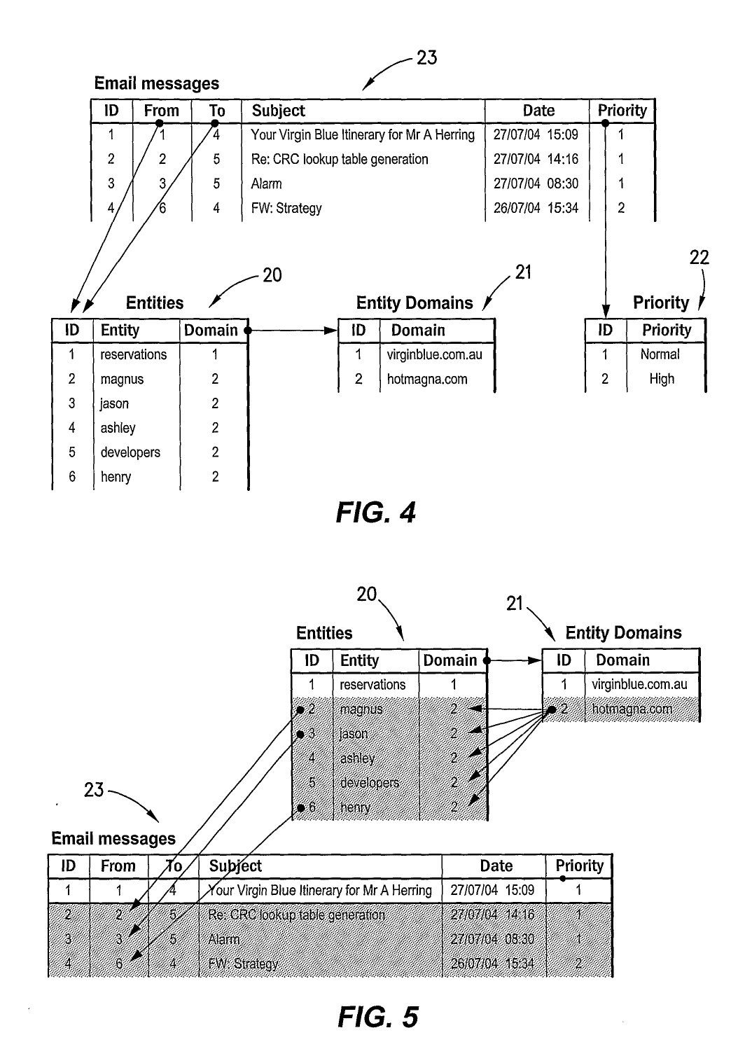

Normalisation is a process of identifying related data within information and using a linking/indexing mechanism to store these relationships with the information itself. In the above example, a normalised view of the email messages may look like the series of relational tables illustrated in FIG. 4.

In this example, the common relationship information such as From, To addresses has been split out into Entity 20 and Entity Domain tables 21, along with information with finite possible values such as Priority 22. The original Email Messages table 23 now stores links rather than the raw information. The information is now normalised.

What advantage does this offer? It provides a very quick, efficient and highly scalable means of cross-referencing data based on these normalised fields using indexes. See also FIG. 5.

### Email Header Inter-Relationships

At a high level, an Email message can be viewed as being comprised of two parts: the Header and the Body. The Header contains a variety of important information that can be used to identify inter-relationships in email streams.

Email Header Information
Email sender
Email recipients (to, cc, bcc)
Reply-To address
Subject
Date
Priority
Message ID/In-Reply-To
References (optional meta-data)
Keywords (optional meta-data)
Comments (optional meta-data)
Implementation specific Extension Fields, such as:
   Original To
   Original Arrival Time
   Accept Language
   Mailer.

By storing this information in a relational form (that is, in a relational database) the following kinds of inter-relationships can be readily identified:
Identify all emails that were exchanged between Company X and Company Y for the month of July 2004.
Identify all emails that were sent from company managers to internal recipients containing “Memo” in the subject in a given week.
Identify all emails containing one or more PDF attachments received from Company Z last year.
Identify, based on volume of sent emails from the payment gateway system containing “Order Receipt” in the subject, the top ten customers that purchased products online. Drill down into totals per month (i.e., in February 2004 we Company X made 112 online purchase, in March 2004 that number was 240, etc).

### Textual Inter-Relationships

Identifying and managing relationships in free text fields, such as Subject field for example, is more complex, as this information is not inherently normalisable. Different emails all with a subject line relating to the same topic can be comprised of a variety of different actual text. For example:
“Memo: Fire Drill this Afternoon”
“memo—there is afire drill this afternoon”
“ATTENTION: FIRE DRILL TODAY”
“(MEMO)—FIRE DRILL today.”

These four subject text strings all relate to the same topic, yet using a character by character comparison are completely different strings. Standard normalisation techniques therefore will not work for efficiently identifying textual relationships.

However, identifying textual relationships by manually searching every subject string in the Library may be time consuming, so some degree of indexing may be utilised to make the process more efficient.

Full-text indexing and searching engines such as Lucene™, provide an efficient means of building case-insensitive word indexes, so sets of messages containing instances of a given word or combinations of words can easily be identified. Advanced features of these indexing and searching schemes even allow for word proximity searches to be made—i.e. find messages with the word “Apple” occurring within 1-10 words of the word “Orange”.

The challenge lies in picking the right balance of words to index on. Obviously common English words such as “the”, “or”, “and ”, “it” and “I” would not be good indexing candidates as almost every single message would be added to the index.

### Email Body Inter-Relationships

In addition to the inter-relationships readily identified through the header information, the actual email body can also be used to identify relationships. For instance, it may be desirable to identify all emails in the database containing the term “Email Relationship Management” somewhere in the body.

Like subject strings discussed above, information in the body is inherently denormalised—and full text-searching indexes on particular important keywords may need to be maintained in some embodiments.

### Encoded Emails and Attachments

Full text search engines are designed to index and search plain text content. Emails however can be encoded in a variety of formats, such as HTML or Rich Text Format and will also include attachments such as PDF, Word documents, Open Office documents etc. Both non plain text content and document attachments should be searchable using the same full text search engine utilised for normal plain text emails.

Our proposed scheme for addressing this issue is to create an Open-API plug-in architecture that the full text search engine in the system could utilise to decode email content and attachments into plain text content for searching and cross-referencing purposes. Plug-ins would then be supplied for decoding PDF, Word, HTML, RTF, wimnail.dat documents to ensure their contents could be used in performing full-text searches of the database.

### Query Language

Once the emails are stored in the system in the database 10 in relational form (in particular in the index 18), then the system provides an interface 17 by which a query language may be utilised to query the database 10. Queries formulated in the query language are known in this document as “Email Perspectives”.

An Email Perspective is a particular defined “view” of the database based on a set of relationship criteria. In this regard, an Email perspective of the database is analogous to a SQL Query (and its resulting result set) in a RDBMS. Instead of returning generic row data based on relationship criteria, an Email Perspective will contain a set of email messages contained in the database.

An Email Perspective therefore is a reusable and dynamic definition of a particular cross-section of the database, defined by a set of relationship requirement criteria.
Reusable: The Email Perspective can be defined and stored for reuse and shared between different users. Email Perspectives will only show the Email messages defined by that perspective that are accessible by that user. That is, a given Email Perspective definition may show different sets of messages for different users based on what their access rights are.
Dynamic: The Email Perspective will show new messages that fit its relationship requirements as they are added to the Library.
Combinable: Email Perspectives can be combined and nested in AND/OR relationships to form new Email Perspectives. For instance an Email Perspective defined to return all Sales staff correspondence can be combined in an AND relationship with an Email Perspective defined to return all internal organisation correspondence to define a new Email Perspective that will result in all internal Sales staff correspondence. This process will greatly simplify the process of defining and managing Email Perspective definitions.

Traditional mailbox systems use the ubiquitous Folder metaphor to manage Email relationships—i.e. new mail is in the In-box folder, sent mail is the sent folder, work mail gets filed under the Work folder etc.

Email Perspectives offer a number of clear advantages over the traditional folder based approach for the end user mail management experience:

### Automatic Email Management

As Email Perspectives are fully dynamic ways of obtaining a subset of the Email Library, to the end user they represent an automatic email management mechanism. In contrast to folders, no effort on behalf of the user is required to “move” or “file” an email in a target perspective.

Some folder based email systems attempt to mitigate the problem of manual email folder management through the mechanism of filter definitions and automatic execution of the filters on the In-box to move inbound mail to target folders.

Putting the other advantages listed here aside, Email perspectives are similar to Email Filters in this regard, with two key differences—Email Perspectives can be defined and applied retrospectively at any stage to emails in the Library, not just those in the In box, plus they permit a single email to exist across multiple views simultaneously (see below).

### Efficient Email Management

Email Perspectives can be set up once, stored and reused across any number of users. Importantly this allows for a central Library of predefined perspectives that return results relevant (and access controlled) for a given end user of that perspective.

Contrast this with the current complex manual configuration of folders and filters in modern email systems that have to be performed on a per-client basis.

Email Perspectives provide the end-user with a set of predefined “views” into the corporate email pool, allowing them to monitor sets of email traffic relevant to particular tasks without being cluttered by email not relevant to that task.

For example, an end user may set up separate Email Perspectives to monitor communications from fellow Developers, another perspective to monitor bug reports from external customers sent to any of the developers, plus a separate perspective to monitor emails from their friends regarding social arrangements. Email Perspectives provide an efficient way to automatically separate out these emails into different logical views, including emails from multiple mailboxes. No manual folder filing is required and there is no need to hit the delete key!

### Multi-Email Views

Email messages and Email Perspectives have a 1:many relationship. A given email message can be apart of any number of perspectives, unlike traditional folders which mandate that an email message must belong to one and only one folder.

This 1:1 relationship of folders is particularly limiting when trying to organise email on different criteria, for example if you want to keep track of both all work emails and work emails relating to a particular topic separately.

### Multi-Mailbox Views

Email perspectives match email messages across the entire database 10, not just a single email account. Backed up by the system security and access mechanisms, they provide an easy and secure way to share email, communications within subsets of an organisation.

Some folder based email systems use the concept of shared folders to allow email to be shared across multiple accounts, but these cannot be applied retrospectively or in a manner that allows email to be stored in multiple folders like Email Perspectives.

An alternative approach to shared folders has been the use of distribution lists, usually cc'd on an email message to ensure all members of that group receive a record of the correspondence. For example, the Sales Group may have a sales@comanyx.com distribution list that all sales correspondence to external customers is bcc'd to. Sales staff may combine this with a filter rule to place sales@comanyx.com email they receive into a special folder. Email Perspectives provides a supplementary mechanism for this that solves the following problems inherent of this approach:
Email Perspectives are fully retrospective. If a new Sales member joins, the “Sales Perspective” allows them access to every sales correspondence in the database 10. In contrast the distribution list approach only allows that new Sales staff to receive sales correspondence sent after they started.
Email Perspectives do not require the sender or receiver remember to cc or bcc in any distribution list to capture email. As the system captures all email sent or received in the organisation and Email Perspectives show information stored in the database 10, this is fully automatic and able to capture every relevant email.

In this embodiment, the Email Perspective query language is a language that sits over SQL. As an example: let's say that I want to query all emails sent from a person called Adam to a person called John at a organisation called Companyx.

The SQL might look something like this:
select * from messages where
from=(select entityId from entities where address=“adam@companyx.com”) and
to=(select entityId from entities where address=“john@companyx.com”);

The SQL will also be very specific to the database technology being used and is not particularly readable or intuitive to the average end user as to what task it performs.

Email Perspectives, whilst being primarily UI driven, might be defined as something like:

Perspective (“From Adam to John”) is:

from=adam@companyx.com

to=john@companyx.com

The difference here is we are defining a higher level abstraction that is very specific to the user domain—that is defining email search criteria. The database specifics, such as table names, column names, joining statements, etc. are all hidden from the end user, allowing for a more intuitive query interface specifically customised to email and independent of the actual database technology being used.

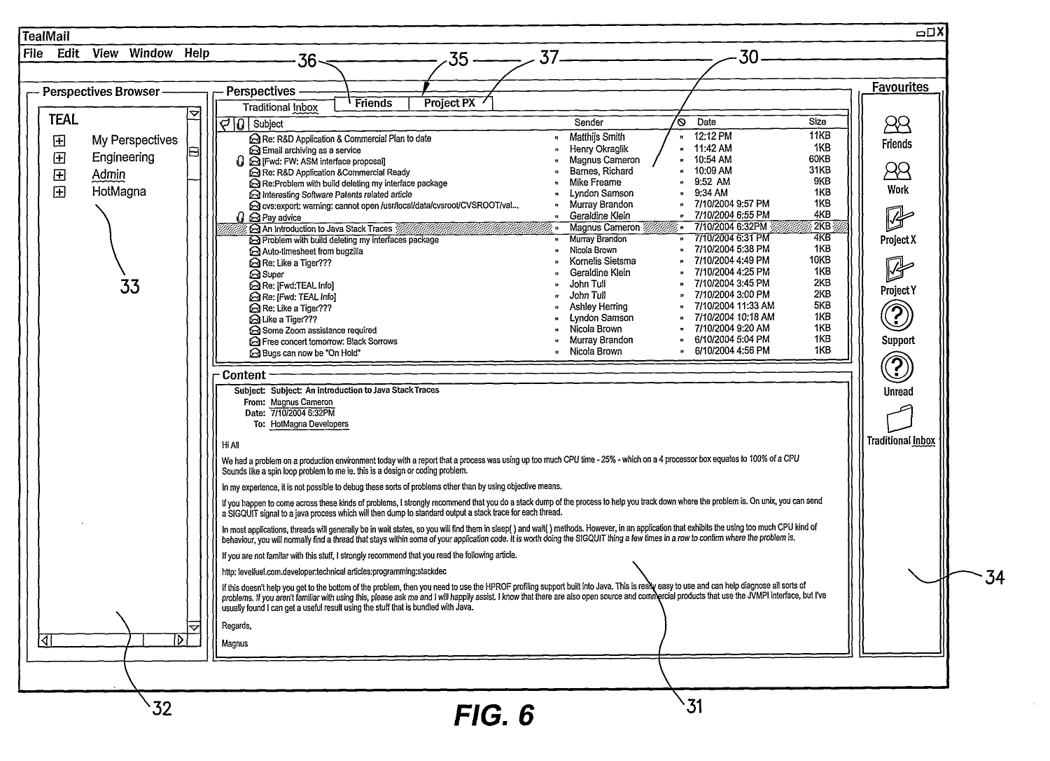

FIG. 6 is an example of a graphical user interface (GUI) that may be provided by the apparatus of the present invention, in the form of user client software on a user client device.

The view of the Perspective is much like the view of a folder, in the way items are displayed as a table of email header information and a split pane showing the content of the selected email. In FIG. 6, it is actually the “traditional” In-box which is shown open with the split pane showing the header in one pane 30 and the email content in the other pane 31. One advantage of this GUI is that the traditional In-box where emails are allocated by the email server 2 is combined with the queries of the TEAL server 11 and database 10 in the form of Perspectives. In other embodiments, the traditional In-box may be done away with and only Perspectives utilised to query the TEAL server 11 and database 10.

Referring again to FIG. 6, on the left hand side “Perspective Browser” 32 allows access to saved Perspectives 33, including those that may be pre-defined and shared across the company. Some of the Perspectives will be Read-only for the average employee (i.e. they could not re-define what “Admin” was). On the right, “Favourites” can be saved 34. People will quickly work out which Perspectives are of the most use of them and set up short cut links in the Favourites Section 34.

Perspectives may also be “Tabbed” 35. Like Mozilla™ with its tabbed web pages, the GUI client of the present apparatus also shows Email Perspectives currently opened in separate Tabs (“Friends” 36 and “Project PX” 37 in this example).

It will be appreciated that this GUI is merely one example embodiment only, and many variations could be implemented.

### Combining Perspectives

Perspectives can be combined to provide views that are unions (OR relationships) or intersections (AND relationships) of those views. To give an example, let's say we had a set of simple perspectives defined:

A. All Emails in the last 10 minutes

B. All Emails in the last 30 minutes

C. All Emails in the last hour

D. All Emails in the last 24 hours.

1. All Emails from people in “My Friends” address group

2. All Emails from people at Company 1

3. All Emails sent to people at Company 2.

The ability to allow users to easily (i.e. drag-n-drop) combine perspectives allows for more refined searches to quickly and easily be generated. So if I have Perspective 2 open (All Emails from people at Company 1) I can drag in Perspective 3 to make that perspective now (All Emails from people at Company 1) sent to people at Company 2). Furthermore I can drag in Perspective A and it becomes (All Emails from people at Company 1 sent to people at Company 2 in the last 10 minutes).

This is very powerful—from a small set of basic defined perspectives we can easily create very sophisticated email perspectives through drag-n-drop combination. Most people are going to be very ad-hoc and reactive about what email perspective views they want to see and the ability to combine simple perspectives like this allows them to generate the appropriate perspective in near-real-time.

### Information Returned by Perspective Queries

Perspective queries will generally return a list of emails from the Library Archive 19 which fall within the Perspective. The user can then access each of the emails from their mail browser. Alternatively or additionally, however, a Perspective could return other email information e.g. from the Library Index 18 such as the email Subject Matter Head or other information.

### Security

The server 11 and database 10 also implement secure access protocols. Managing email information across an entire organisation requires that information is held in a secure manner that protects access to such data, providing appropriate levels of privacy within the organisation. For example, the CEO may want access to all company emails, but only allow his Personal Assistant to access to his emails. The Sales Manager may require access to all his immediate Sales staff emails, but nobody from R&D should have access to the Sales email.

The TEAL server 11 incorporates security protocols to:
Ensure all retrieval of email from the system is fully authenticated and verified. For any given request made of the TEAL server 11, it knows who the end user making that request is.
Provide hooks for integrating the authentication process with LDAP or MSAD based authentication schemes.
Allow Administrators to configure which email accounts each end user has access to, or which sub-sets of email accounts a user has access to (for instance, only allowing the Sales staff to have access to each other Sales staff email accounts for email messages sent and received by registered Sales customers).
Provide a rule based means of generating access settings. For example allow anybody access to emails that have been received from Client X.
Ensure that users can only see emails in the database 10 for which they have access to.
Allow the ability for an audit trail of which users accessed which emails and when it was accessed to be maintained by the system.
Recognise distribution lists used by the organisation email system and provide access rules based on those lists. For example, allow any member of the sales distribution list access to emails from client Y.

Whilst the apparatus provides privacy and security mechanisms, it should also go hand in hand with organisational policy practices to ensure staff know who has a right to read their email.

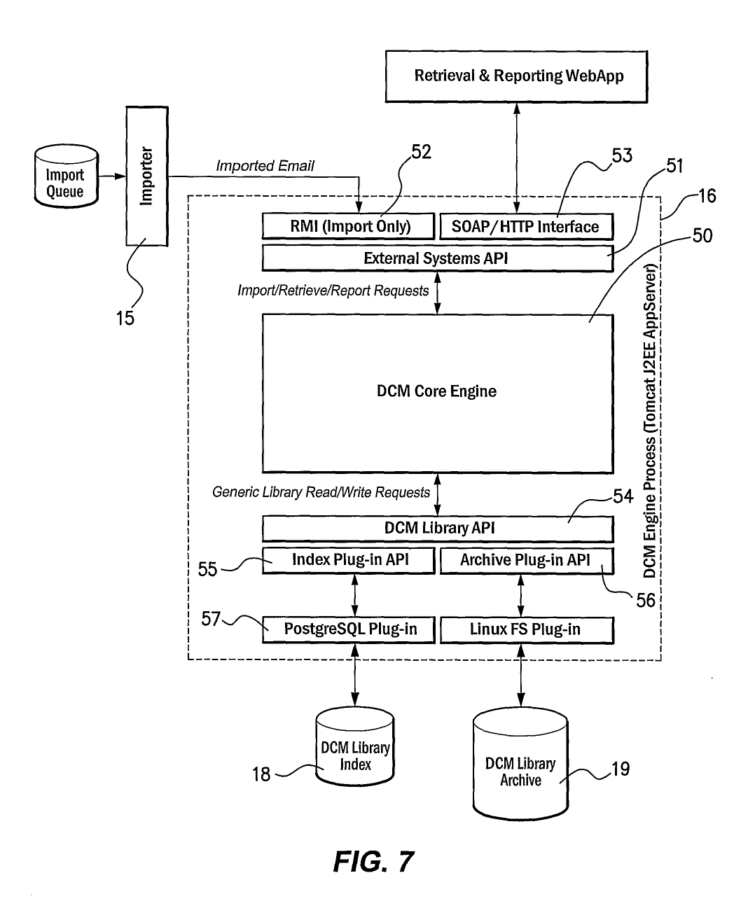

Referring now to FIG. 7, a more detailed description of the DCM Engine 16 implementation will be given.

The DCM Engine 16 is comprised of a number of internal interfaces and processes running on a single Tomcat application server. Its function is to import new digital content (emails) into the Library 10, co-ordinate requests for content retrieval and report information from external clients.

Internally, the Core Engine 50 handles the import and retrieval requests received via its External Systems API 51. In this embodiment, we are providing both RMI and SOAP over HTTP 53 inter-process communication (IPC) mechanisms for the Importer/Retrieval and Reporting WebApp to access the Library 10. The RMI interface 52 and SOAP/HTTP interface 53 form the interface 17 as schematically illustrated in FIG. 3, together with the external systems API for API 51.

The DCM Engine 16 acts as a central co-ordinator for all actions on the database 10 (also termed the “DCM Library”). Internally it utilises a DCM Library API 54 to access the Library 10. This allows for custom plug-ins for particular storage mediums to be designed and added to the engine in such a way that both the Core Engine 50 and all its externally communicating processes remain isolated from the technical implementation details of how the Library 10 is implemented. This will allow for future reuse for other digital content management activities.

The Core Engine 50 is responsible for taking the Imported email data and storing it appropriately in the Library 10. At a high level, the responsibilities of the Core-Engine can be broken into three categories.

### Email Importing and Storage Management

Normalise key relationship data such as Date, Subject, To, From, CC, BCC, Content and Attachments.
Store email meta-data in the Library Index (relational database).
Store raw email content and attachments in the Library Archive (file system).
Identify and eliminate duplicate emails.

### Email Retrieval

Handle query requests to retrieve header information for emails stored in the Library.
Handle query requests to retrieve the body and attachment contents of a given email.

### Reporting and Monitoring

Collate traffic and storage statistics on the library and use them to generate periodic reports and graphs that can be served up to the Reporting WebApp to monitor performance.

### External Systems API

The External Systems API 51 provides a generic way of interfacing to the Core Engine in-process. It provides interface calls to import new email into the Library and execute email retrieval queries on the Library content. Different IPC implementations of the External Systems API can be used to expose this functionality for external processes to access. In this embodiment RMI 52 and HTTP/SOAP 53 are provided.

### RMI Interface

The RMI interface 51 is for import only and is aimed at providing a high-throughput means of inter-process communication between the Importer and the Engine, both of which are Java processes running locally on the same server.

### HTTP/SOAP Interface

The HTTP/SOAP Interface 53 exposes the External Systems API as a SOA style interface that can be accessed via SOAP over HTTP. This interface is used by the Email Retrieval and Reporting WebApp to provide a user-interface into the DCM Library 10. Note that other interface technologies can be utilised in other embodiments.

### DCM Core Engine

The core engine 50 receives requests to import email and retrieval/reporting requests via the External Systems API. It is responsible for co-ordinating those requests using the Library API. As the Engine runs in a Tomcat J2EE Application Server, it will support a scalable, multi-threaded request engine that can handle multiple inbound requests from the Importer and end users via the WebApp Interface.

### DCM Library API

The Library API 54 provides a technology independent interface into the DCM library 10 for the Core-Engine 50 to use in processing inbound import and retrieval requests. A plug-in architecture allows for different storage technologies to be used in implementing the Library 10 transparently to the Core-Engine 50. This will allow different and multiple simultaneous database and file systems to be used with TEAL in the future with minimal impact on the Engine system.

In this case, the plug-ins are illustrated as Index Plug-In API 55 and Archive Plug-In API 56.

### PostgreSOL Plug-In

In this embodiment a PostgreSQL plug-in 57 implements the Library Index using a PostgreSQL database.

### Linux FS Plug-In

Linux FS plug-in 58 that implements the Library Archive using the Java 10 APIs, but tuned for optimal performance on a Linux file system.

The Core-Engine 50 can be used with multiple plug-ins concurrently. For example, a company may be using Oracle™ for its database storage, so the Engine 50 uses a Oracle™ database plug-in.

This architecture has a number of advantages. If a company wishes to migrate to another database type of architecture, for example, they can phase this in over a period of time still using the email system of this embodiment of the present invention. For example, if they wish to migrate from Oracle to Postgres, all that is required is the Postgres Plug-in is added to the Core-Engine 50 so it can communicate with both Oracle and Postgres databases. New emails may now be stored in the Postgres database, whilst for now the old email and email meta-data continues to be managed by the Oracle database. A query to retrieve a set of emails may result in both databases being queried (transparently from the end user).

### Handling of Duplicates and Attachments

Emails being processed by the apparatus of this embodiment are checked to see if they are a duplicate of an already existing email. Each email will have a MD5 hash code calculated based on its contents (128 bit key with an extremely low probability of two binary files having the same key) and the hash code is stored in the database. As new emails arrive, their MD5 hash code is quickly compared with other codes in the database—if it already exists the email can safely be considered a duplicate. The duplicate does not need to be processed and stored, and in this embodiment it will not be.

Attachments are stored separately from email content in the file system, with the database 10 maintaining the relationship info (i.e. which attachment belongs to which emails)—this is a 1:many relationship, so a given attachment that may exist in several emails is only stored once on the file system, saving disk space. The process of recognising identical attachments is also done through an MD5 hash code (as there may be several different versions of “patent.doc”, all with the same name and possibly the same size, so we identify identical attachments based on binary contents).

### DCM Library 10

As discussed above, the DCM Library 10 is comprised of two parts: the Library Index 18 and the Library Archive 19. The Index 18 is a relational database that maintains indexes and tables relating to the email meta-data mined from the email. The Archive 19 is a scalable file based storage of the actual email content (header, body and attachments).

The Library Index 18 and the Library Archive 19 are directly related to each other and are both maintained by the DCM Engine 16 when new emails are imported into the Library 10.

When retrieving emails, the Library Index 18 provides a relational and indexed view of the email data held in the Library Archive 19 and can be used to quickly identify and find particular emails in the file based archive 19.

### Unique Identification

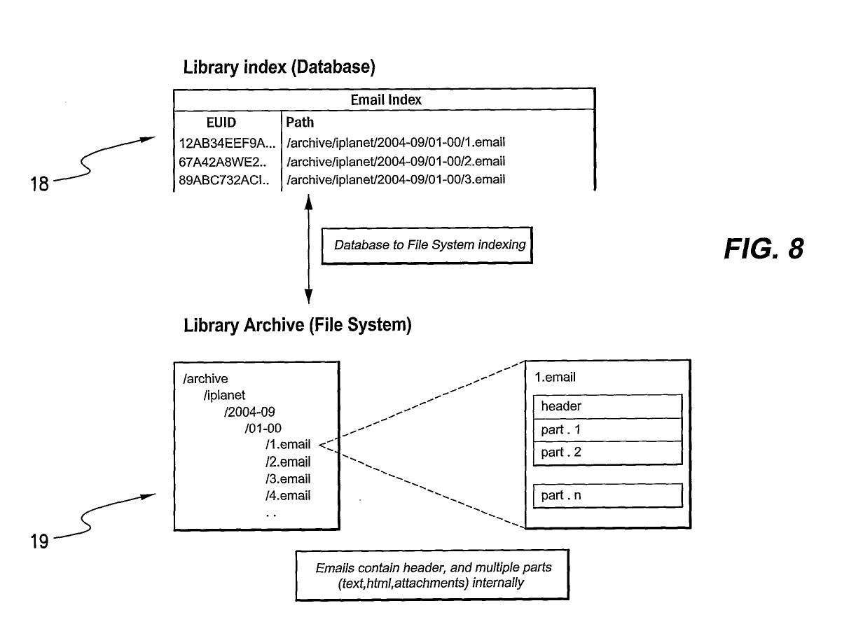

Referring to FIG. 8, emails are uniquely identified and tracked in the DCM Library 10 by means of a Email Unique Identifier (EUID). When captured emails are first Processed for storage in the DCM Library 10, they will have a EUID assigned to them as a first step.

The EUID is generated from performing a 128 bit MD5 identifier based on the internal contents of the message as discussed above.

Once an EUID has been assigned, all database records associated with that email in the Library Index 18 can be retrieved using that given identifier.

### Library Index

The DCM Engineer 16 receives parsed email content from the Importer 15 that has identified the meta-data information from their header content for relational storage in the Library Index 128. The meta-data may include:
Subject
Date
From
To Recipients
CC Recipients

It may include further information, as discussed above, including information from the email content. This information is stored and tracked against the Email's EUID.

### Library Archive

The Library Archive 19 uses organised directories and files on the TEAL system to store the raw email content (header, body and attachments). See FIG. 8.

When captured Emails are received and processed, their raw content will get placed in a single file in the Library Archive. The directory the files are stored in is dynamically determined based on the current system time and the domain the email belongs to.

Email files are linked to their EUID through the main Email Index table in the Library Index 18. A path field in that table allows the corresponding file in the Archive to be identified for any given email in the Index. Example table extracts for the Library Index 18 and Library Archive 19 are illustrated in FIG. 8.

### Duplicate Email Elimination

It will be possible for the same email to be captured and sent to the TEAL Server 11 multiple times. The TEAL System will ensure that only one copy of the email is stored in the DCM Library 120 by identifying and ignoring duplicate emails.

The DCM Engine 10 will be responsible for identifying duplicates by:
1. Generate an EUID for a captured email based on its raw binary content.
2. Check to see if that EUID already exists in the system. If so then the email is considered to be a duplicate.

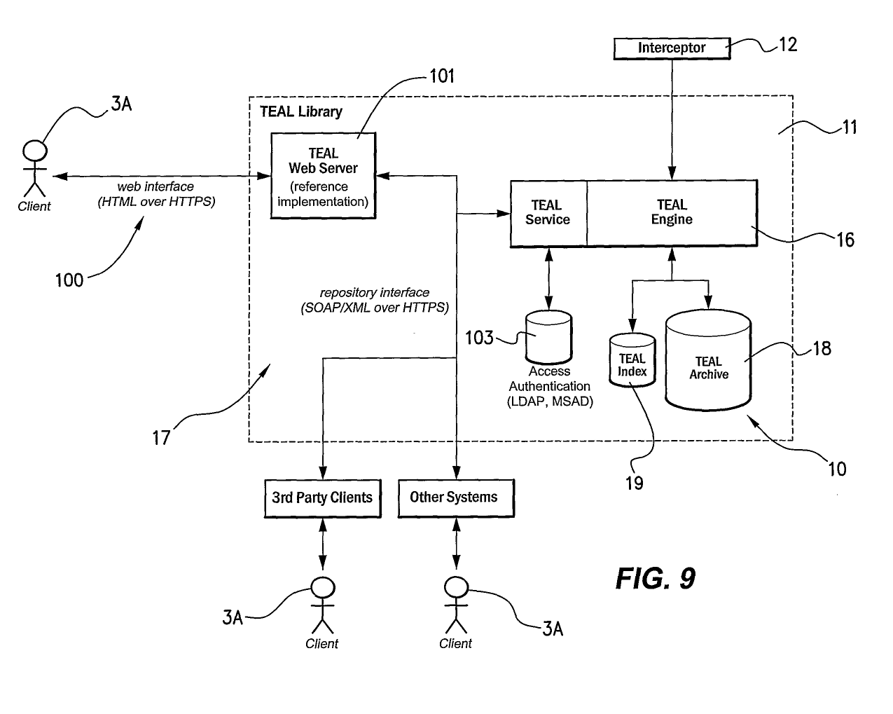

FIG. 9 illustrates implementation of an alternative embodiment of the present invention. The embodiment shows some more detail on how an Interface 17 of the FIG. 3 apparatus could be implemented. The components of the FIG. 9 embodiment have the same function as equivalent components of the FIG. 3, they have been given the same reference numerals and no further description of them will be given.

The Interface is generally indicated by reference numeral 17. The Interface 17 provides a SOA style surface that provides a SOAP interface, accessed over a secure HTTPS connection 100. This provides the following architectural advantages:
The interface is geared towards talking to computer clients rather than human clients
The web interface 101 can be built on top of the SOAP interface to provide a human client interface.
Open, standards based interface allows third party tools to develop custom client interfaces using a variety of technologies.
Open, standards based interface allows external systems to easily integrate into the apparatus and the leverages capabilities.

At a high level, the SOAP interface will provide access to the to following capabilities of the system.
Authenticated session management 103. All access to the system must be authenticated to ascertain end client permissions and to provide an accurate access audit trail.
Email query interface allows for complex mail queries to be defined, saved and executed to return a set of mail header information matching that query and the client's access level.
Retrieval of mail contents and attachments for a particular mail header if the end client has permission to access that information.
Administration (if the end client is permitted) of system users and their authentication levels and rights.
Administration (of the end client is permitted) of mail archiving and purging policies.

The system will protect the privacy of the data it is handling (which in many cases may be a legal requirement, not just corporate policy) through the following mechanisms:
Inbound mail message feeds from the Email Interceptors will be transmitted over an encrypted secure socket layer (SSL) connection to ensure the mail data remains private whilst in transit to the TEAL system.
Email indexing data sent to the TEAL Index will utilise the security mechanisms supported by the database server hosting the index. For example, the Oracle JDBC driver can be used in SSL mode to communicate over a secure, encrypted channel with an Oracle database server.
The database and file systems hosting the TEAL Index and TEAL Archive data respectively, will utilise the infrastructure/operating system level security mechanisms provided by the vendors of those technologies to protect the data privacy

Many organisations require that at least some, if not all, email communications be secure. This may be dealt with by encrypting email communications by some form of encryption, such as PGP. Security may be required for email communications both internally within an organisation and externally.

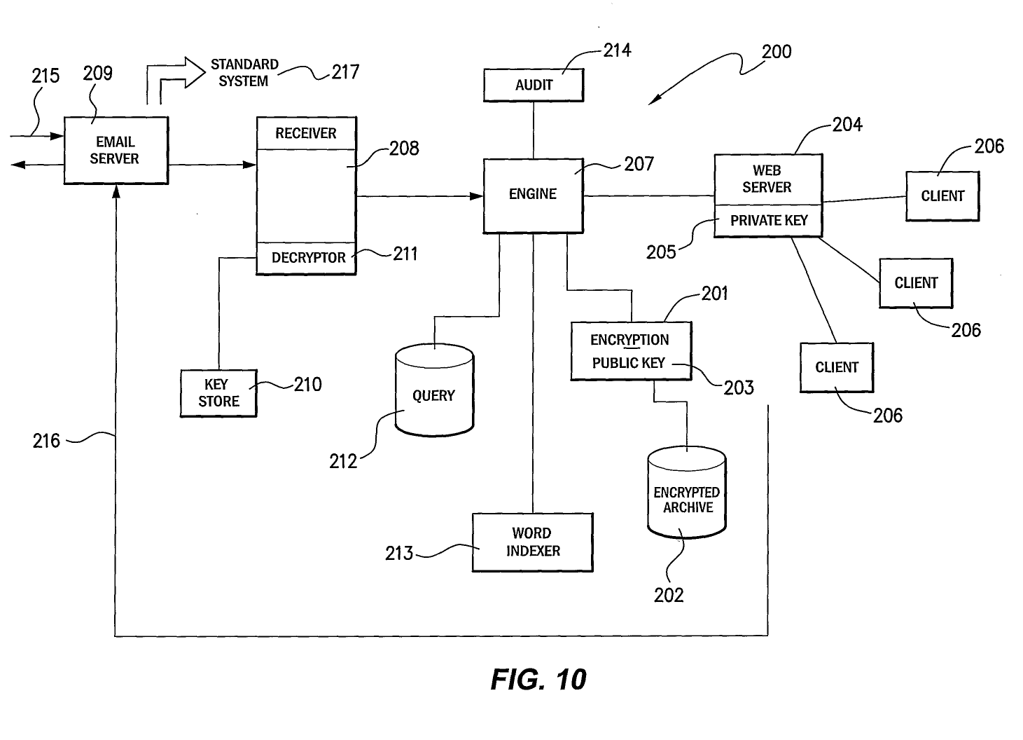

As discussed in the preamble of this specification, there is a requirement (both from a legal point of view and from a organisational efficiency point of view) for storage for email information for at least a predetermined period. The storage of secure emails (e.g. encrypted emails) pose some difficulties. In particular, how are the encrypted emails subsequently to be accessed? How are they to be stored when they are usually directed to an individual with a particular private/public key pair? In accordance with an embodiment of the present invention, a method and system for processing emails is implemented which is arranged to deal with secure emails so that the secure emails can be securely stored and also accessed by designated users. In the embodiment to be described in the following, with reference to FIG. 10, the system architecture is based on the TEAL system which is described above in relation to FIGS. 2 through 9. Stored secure email can be accessed by database queries such as the queries described above. The invention is not limited to a TEAL-type architecture, however, and it may be implemented in alternative embodiments utilising different architectures.

In the following embodiment, a system and method is described which is used to process secure emails for subsequent access by an organisation's legal department. Secure emails that are addressed to users within the organisation are stored in a database which may be accessed by designated user clients (in this case, being members of the legal department of an organisation who need access to the secure emails for legal purposes, e.g. for Discovery purposes). The invention is, however, not limited to this particular application.

Referring to FIG. 10, a system in accordance with an embodiment of the present invention is illustrated, for storing secure emails in a secure fashion, but enabling access as required. The system, generally designated by reference 200, includes an encryption means 201 which is arranged to encrypt received emails, and a database 202 which is arranged to store the encrypted emails for later access.

Note that the encryption utilised by this embodiment is public key cryptography. Any type of secure system may be utilised, however, and the present invention is not limited to public key cryptography.

The encryption apparatus 201, is arranged to encrypt emails (or re-encrypt emails that have been decrypted), with a common key, in this embodiment being a single public key 203. In this example embodiment, a web server 204 has access to a securely stored private key 205 which is able to decrypt emails encrypted with public key 203. Clients 206 (computing devices with access to the web server 204) are able to query the encrypted archive 202 via the web server 204 and an engine 207. In this example, the clients have the appropriate security to allow them to access the encrypted archive 202 via the web server 204 and engine 207. They may be members of a legal department of the corporation, for example, required to have access to all the secure emails on the encrypted archive 202 for various legal and/or record keeping purposes.

The Engine 207, Web Server 204 and Database 202 architecture are based on a similar architecture to the TEAL embodiment described previously with reference to FIG. 9.

The system also includes a receiver 208 which is arranged to receive both incoming and outgoing emails from the organisation's email server 209. The receiver 208 may be based on the TEAL interceptor disclosed above in relation to FIGS. 2 through 9. Emails may be received by any one of the following methods: Exchange Interceptor, SMTP Sniffer or/and SMTP Proxy.

The receiver 208 has access to a secure key store 210. This stores all the public/private keys which are used by members of the organisation utilising the organisation's email system. These are stored in an encrypted file on disk. Each key has a unique alias (ID) for quick retrieval during processing. A database (not shown) stores the relationship between the users email address and the keys alias, in order to match the alias' with the email address. The secure key store has a complex security password for access, so that the key information is stored securely. The receiver 208 includes a decryptor 211. If encrypted emails are received by the receiver, the decryptor 211 is arranged to fetch the appropriate key(s) required to decrypt the email. Each key is located via its alias (as identified by the email address of the email).

Decrypted emails are provided to the TEAL engine 207 from the receiver 208. The engine 207 performs a number of functions; Database 212 stores query index information in the form of metadata relating to information from the header, email address, and other “non-secure” information from the email. This is done in a similar manner to the library index 18 discussed above. The index is used to store all the email messages header information to, from, cc, subject fields etc, so that it can be searched.

In addition, as discussed above, the engine encrypts all the emails it receives (including re-encrypting those that have been decrypted by the decryptor) and stores them in encrypted form in the encrypted archive 202. Each email is encrypted using military grade AES128 encryption. The unique key used to encrypt the email is wrapped using the public/private key pair generated at install time. The private key 205 is stored on the web server 204.

A word indexer 213 is also provided to index words that exist within the content of the emails. Note that this does not index the content of the emails, but merely words that exist within those emails so words searches can be carried out. The index 213 pre-indexes all words within an email and stores this information on disk. An example of what an index file on disk looks like is below.

Index Word: email

Index File Location: ,root./e/m/a/i/l.index

The email id is appended to this file when the email contains the word email.

This file is in a binary format.

As the emails are word indexed it is possible to execute searches as the index content. Currently in this embodiment there are two types of searches that can be carried out, “Contains All” and “Contains Any”.

Contains All

This is like doing a ‘AND’ operation on all words in the search string.

E.g.

Search String: ‘Email Outlook’

This search string says “Find me all emails that contain the word ‘Email’ and ‘Outlook’”

1. Find me all emails which contain the word ‘Email’

2. Find me all emails which contain the word ‘Outlook’

3. Find the intersection between both sets of email ids.

Contains Any

This is like doing an ‘OR’ operation on all words in the search string.

E.g.

Search String. Email Outlook’

This search string says ‘Find me all emails that contain the word Email’ OR ‘Outlook’”

1. Find me all emails which contain the word ‘Email’

2. Find me all emails which contain the word ‘Outlook’

3. Find the union between both sets of email ids.

An auditor 214 is also provided. The auditor audits all access to email, metadata and content, so that administrators (for example) can see what is being accessed and who by.

In operation, therefore, all emails that pass via the email server 209 of the organisation are obtained by the TEAL receiver 208 and stored in the encrypted archive (after any decryption that may have been necessary). This includes both emails which are being sent to the organisation's email server 209, externally originating (215), and also emails which are being sent externally from the organisation's system, internal emails (216).

The application illustrated in FIG. 10 is for an encrypted archive 202 storage for application for legal reasons e.g. for access by a legal Discovery team. All incoming and outgoing emails are loaded into the encrypted archive 202. For the purpose of the general email system of the organisation, the email server 209 additionally operates with a standard system 217 (not shown), utilising the folder paradigm.

In an alternative embodiment, the standard system 217 may be a standard TEAL system as described above with reference to FIGS. 2 through 9.

In a further alternative embodiment, the engine 207 may operate an encrypted archive 202 and also a standard archive (not shown in FIG. 10) which is able to be accessed without any decryption. Emails which do not require encryption (e.g. perhaps those that were received in unencrypted form externally/internally) may be stored in the standard archive for general access.

In yet another alternative embodiment, all the emails are stored in encrypted form on the encrypted archive 202. Users within the organisation access the emails using TEAL-type queries. Security controls are provided to ensure that users can only access emails that they have a security level for. Some emails (e.g. encrypted emails that were not intended for them personally) will not be accessible unless the appropriate security is in place.

For some applications, it may be a requirement for a number of archived emails to be sent to a remote location. For example, in legal Discovery circumstances, it may be necessary to send many email documents to a particular location. To facilitate this, the system of this embodiment includes a Download Bundler. The Download Bundler provides a mechanism for a TEAL user to securely export emails from the TEAL server to remote locations. It does this by encrypting/re-encrypting the emails stored in the archive and bundling them up inside a self executing Java application. The encryption requires a password to be entered by the client to extract the email data as plain text index. The encryption mechanism used in this bundler is much the same as that used in the TEAL archive.

In the above system, the emails are encrypted into the encryption store SMIME format. SMIME emails are encrypted MIME messages. The encryption works by encrypting the emails with the same type of AES encryption (this varies depending on the type of SMIME emails). The key used for encrypting the email is then wrapped using the receiver's public key. If there is more than one recipient then the key is wrapped multiple times. When the recipient receives the email, they will then use their private key to unwrap the AES key used to encrypt the email content.

Embodiments of the present invention may be implemented utilising any appropriate software/hardware architecture, in accordance with functionality described herein. In the above embodiments, the apparatus is being implemented utilising a server/client type architecture. Any other available hardware/software architectures may be used to implement the invention.

In the above embodiment, a single common encryption key is used to encrypt the emails to be loaded into the encrypted archive. Note that more than one common key may be utilised.

In the above embodiment, public key cryptography is used to encrypt and decrypt the emails. Any type of security system may be used, and the present invention is not limited to public key cryptography.

Modifications and variations as would be apparent to a skilled addressee are deemed to be within the scope of the present invention.

1. A method of processing emails in an organisation having a plurality of email users, including the steps of:
receiving emails;
encrypting the emails with a common encryption key;
storing the encrypted emails in a database; and
enabling access by the email users to the emails via a common decryption key.

2. A method in accordance with claim 1, wherein the step of receiving emails includes the step of receiving emails which have been encrypted with encryption keys associated with one or more of the plurality of email users, and including the further step of pre-processing the received emails to decrypt the encrypted emails, prior to encrypting the emails with the common encryption key.

3. A method in accordance with claim 2, wherein the step of pre-processing the received encrypted emails includes the step of utilising decryption keys associated with the one or more of the plurality of email users.

4. A method in accordance with claim 3, wherein the encryption and decryption keys associated with the one or more of the plurality of users are decryption/encryption keys which the users utilise for email communication.

5. A method in accordance with claim 4, including the step of storing the encryption/decryption keys associated with the one or more of the plurality of email users in a common store which is accessible to enable the pre-processing of the received encrypted emails.

6-7. (canceled)

8. A method in accordance with claim 1, including the further step of extracting non-secure information from the emails and loading a query database with the non-secure information, the query database being searchable to locate emails.

9. A method in accordance with claim 8, wherein the non-secure information includes email header information.

10. A method in accordance with claim 1, including the step of indexing words from the content of the emails by a word indexer to prepare a word index which is searchable to locate emails.

11. A method in accordance with claim 1, including the step of auditing access to the emails.

12-14. (canceled)

15. A method in accordance with claim 1, including the additional step of processing the emails in a standard email system by distributing them to allocated user folders.

16. A method in accordance with claim 1, including the additional step of storing the received emails in unencrypted form in a further database and distributing emails to users in response to a step of querying the database.

17. A method in accordance with claim 16, including the step of implementing security levels so that only users having a predetermined security level can access predetermined emails.

18. A system for processing emails in an organisation having a plurality of email users, the system including:
a receiver for receiving emails;
encryption means for encrypting the received emails;
a database for storing the encrypted emails; and
decryption means including a common decryption key for enabling access by the email users to the emails stored in the database.

19. A system in accordance with claim 18, further including a pre-processor which is arranged to implement a pre-processing step of decrypting received encrypted emails which have been encrypted with encryption keys associated with one or more of the plurality of email users, prior to the emails being encrypted with the common encryption key.

20. A system in accordance with claim 19, wherein the pre-processor is arranged to utilise decryption keys associated with the one or more of the plurality of email users, in order to implement pre-processing of encrypted emails.

21. A system in accordance with claim 20, wherein the encryption and decryption keys associated with the one or more of the plurality of users are decryption/encryption keys which the users utilise for email communication.

22. A system in accordance with claim 21, further including a common store storing encryption/decryption keys associated with the one or more of the plurality of email users, the common store being accessible by the pre-processor to enable pre-processing of received encrypted emails.

23-24. (canceled)

25. A system in accordance with claim 18, further including a query database, which stores non-secure information from the received emails and which is searchable to locate emails.

26. A system in accordance with claim 25, wherein the non-secure information includes email header information.

27. A system in accordance with claim 18, including a word indexer arranged to prepare an index of words from the content of the received emails, the index being searchable to locate emails.

28. A system in accordance with claim 18, including an auditing means, arranged to audit access to the emails in the database.

29-31. (canceled)

32. A system in accordance with claim 18, further including a standard email system for processing emails in the organisation utilising the folder paradigm.

33. A system in accordance with claim 18, further including a further database arranged to store the received emails in an unencrypted form, and queryable via a query language to enable users access to the emails.

34. A computer program comprising including instructions for controlling a computer to implement a method in accordance with claim 1.

35. A computer readable medium including a computer program in accordance with claim 34.
